(19) United States
(12) Patent Application Publication
(10) Pub. No.: US 2007/0168717 A1
(43) Pub. Date: Jul. 19, 2007

(54) Method of Data Protection for Computers

(76) Inventors: Lung-Chiao Chang, Taipei Hsien (TW); Chih-Hung Chen, Taipei Hsien (TW); Yunn-Hung Liao, Taipei Hsien (TW); Hsin-Hua Wen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/278,815

(22) Filed: Apr. 6, 2006

(30) Foreign Application Priority Data
Dec. 13, 2005 (TW) 094144084

(51) Int. Cl. G06F 11/00

(52) U.S. Cl. 714/14

(57) ABSTRACT

A data protection method includes switching a power source of a dual bank DRAM to a battery when external power fails, and placing a bank 1 of the dual bank DRAM into a self refresh mode. A data protection method further includes checking if a power failure occurred previously when a computer is turned on, initializing the bank 0 of the dual bank DRAM and initializing the SMI routine, and enabling the bank 1 of the dual bank DRAM if a power failure occurred. Thus, valuable data retained in the DRAM is prevented from being damaged or lost.

### BACKGROUND

1. Field of the Invention

The present invention relates to a method of data protection for computers, and more particularly, to a method of data protection for computers when there is an external power failure.

2. Description of the Prior Art

In the development of computer technology, people nowadays are more dependent on computers to process and store data. Therefore, stability and reliability of computers is an important issue. When there is a power failure, in another words, when the computer is forced to shut down due to a power failure, data stored in dynamic random access memory (DRAM) will be lost and cannot be recovered.

In fact, there is a battery within the computer for providing a weak voltage required by internal components within the computer when external power is cut off. Therefore, the prior art provides a mechanism that utilizes a quick MOS-FET switch for switching power source for DRAM from external power to internal battery when there is a power failure, thus the problem of losing the data in the DRAM is temporarily solved. Even so, the cost of manufacturing the quick MOS-FET switch is reasonably high, and the MOS-FET operates as an external independent mechanism without fully utilizing the internal component or control method to solve the problem. For computer manufacturers, this has become a liability, as efficiency is limited.

### SUMMARY OF THE INVENTION

The claimed invention discloses a method of data protection, the method comprises examining if there is an external power failure when a computer enters into a system management interrupt (SMI) routine; setting a protective flag to a first value when there is an external power failure; switching power of a dual-bank random access memory (DRAM) to a battery; and setting a first bank of the dual-bank DRAM into a self refresh mode.

The claimed invention discloses another method of data protection, the method comprises examining if there is an external power failure before a computer is turned on; initializing a second bank of a dual bank random access memory (DRAM) when there is an external power failure before the computer is turned on; initializing a system management interrupt (SMI) routine of the computer after the second bank of the dual bank DRAM is initialized; and a first bank of the dual-bank DRAM leaving a self refresh mode after the SMI routine is initialized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a control circuit architectural diagram of a dual-bank DRAM that is commonly utilized.

FIG. 2 illustrates a diagram of a computer system applied in the method of the present invention.

FIG. 3 illustrates a first portion of a flowchart of computer data protection according to the method of the present invention.

FIG. 4 illustrates a second portion of a flowchart of computer data protection according to the method of the present invention.

FIG. 5 illustrates a diagram of a control circuit of a dual-bank DRAM utilized by the method of the present invention according to an embodiment of the present invention.

### DETAILED DESCRIPTION

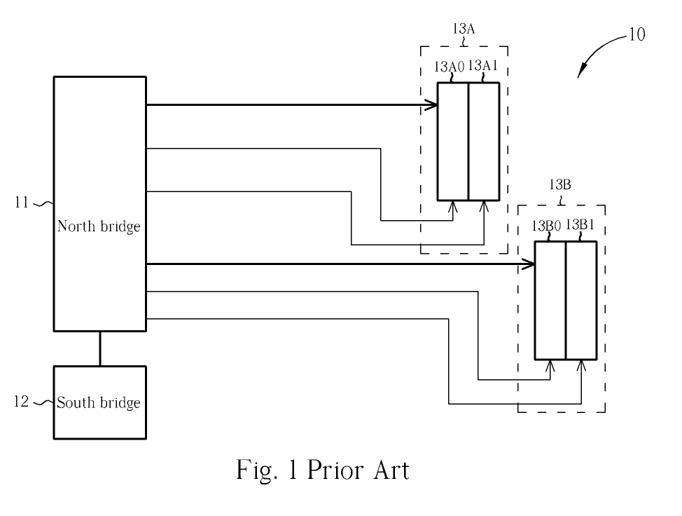

A dual-bank dynamic random access memory (DRAM) can be seen as having two blocks of memory respectively capable of controlling and operating. This type of memory continues to be utilized more frequently. Please refer to FIG. 1. FIG. 1 illustrates a control circuit architectural diagram of a dual-bank DRAM that is commonly utilized. In a typical computer system 10, a north bridge 11 is respectively coupled to and controls dual-bank DRAMs 13A and 13B. The north bridge 11 independently controls two memory blocks 13A0 and 13A1 of the dual bank DRAM 13A, and independently controls two memory blocks 13B0 and 13B1 of the dual bank DRAM 13B. The present invention utilizes the characteristic of two memory blocks of the DRAM capable of operating independently to provide a method of data protection when external power fails.

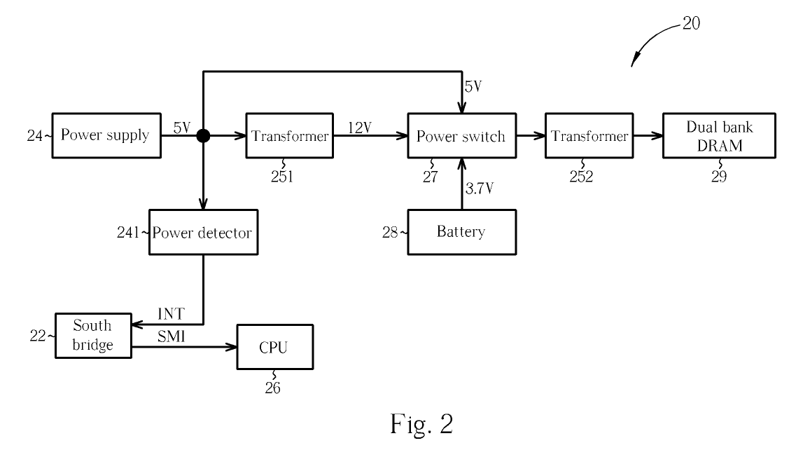

Please refer to FIG. 2. FIG. 2 illustrates a diagram of a computer system 20 applied in the method of the present invention. The computer system 20 utilizes a power supply 24. When the power supply 24 is providing electricity, a transformer 251 of the computer system 20 will boost a 5V direct current and then input the direct current to a power switch 27 to control another transformer 252 that utilizes the 5V direct current. The current is then boosted again to provide for a dual bank DRAM 29 of the computer system 20. When a direct current is interrupted or is too low, electricity cannot be provided due to not meeting standard regulation, power failure, or the computer is being switched off, the present invention controls the power switch 27 to switch the power source of the transformer 252 to a battery 28 such that the battery 28 becomes the power source for the dual-bank DRAM 29. Also, when a power detector 241 detects a problem in the direct current 24, the computer system 20 will then generate an interrupt signal INT to a south bridge 22. The south bridge 22 will then control a central processing unit (CPU) 26 to execute a system management interrupt (SMI) handler routine upon receiving the interrupt signal INT.

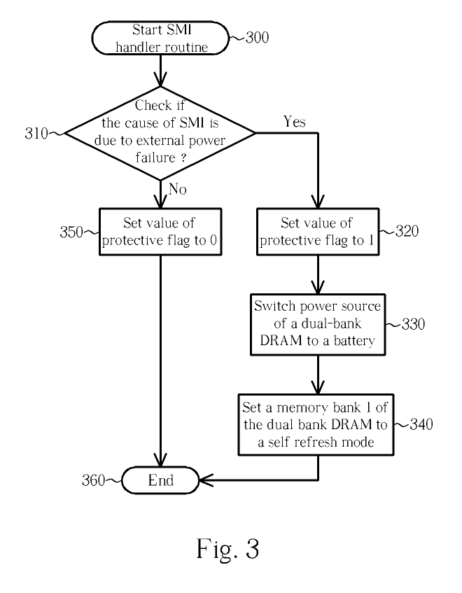

Please refer to a flowchart of FIG. 3 for an explanation of the SMI handler routine executed by the CPU 26. According to the method of the present invention, the computer may enter the SMI handler routine due to an external power failure (as illustrated in step 300 of FIG. 3), and the computer may also enter the SMI handler routine due to other conventional reasons; therefore when the computer that utilizes the method of the present invention enters the SMI handler routine, the computer is first checked for an external power failure, and corresponding measures are then taken to protect data. In the present invention, when the computer is turned off due to an external power failure and later is turned on, a corresponding check and operating steps are executed to recover the data stored during the external power failure. Please refer to FIG. 3. FIG. 3 illustrates a first portion of a flowchart of computer data protection according to the method of the present invention.

Step 300: start SMI handler routine;

Step 310: check if the cause of SMI is due to external power failure: if so execute step 320; if not execute step 350;

Step 320: set value of protective flag to 1;

Step 330: switch power source of a dual-bank DRAM to a battery;

Step 340: set a memory bank 1 of the dual bank DRAM to a self refresh mode; execute step 360;

Step 350: set value of protective flag to 0;

Step 360: end.

Firstly, the SMI handler routine is a mechanism already in placed in modern computers. The present invention adds an additional external power failure circuit to the SMI handler routine to generate a new SMI signal. If an SMI entry is generated when a power failure is detected, the step of data protection provided by the present invention will be added to the SMI handler routine. In addition to a power failure, other situations may also generate the SMI entry in the modern computer architecture according to the present invention. Therefore, when the method of the present invention starts the SMI handler routine, the SMI handler routine first checks the computer to determine if the trigger starting the SMI handler routine is due to an external power failure. When there is a power failure, after the computer system 20 is shut down, a power failure register (PWR_FLR) of the south bridge 22 is being set to 1 as a record.

Step 310 of the flowchart in FIG. 3 utilizes a value of the newly added circuit status to check if the cause of starting the SMI handler routine is due to an external power failure. If the cause of starting the SMI handler routine is not due to an external power failure, then there is no need to protect the data within the DRAM. Hence, the value of the protective flag is set to 0 in step 350 to be recorded as data not being protected. Additionally, there is no need to switch to the battery to provide power to the DRAM because the data within the DRAM is no longer needed after the computer is turned off. Please note that the protective flag can be defined as a field of a bit of an RT CMOS or can be realized in other methods or circuits.

On the contrary, if in step 310 the starting of the SMI handler routine is found to be due to an external power failure, then the data within the DRAM is required to be protected to prevent the loss of important data. Therefore, from step 320 to step 340, the value of the protective flag is set to 1 and is recorded indicating that the data within the memory bank 1 of the dual-bank DRAM needs to be protected. After the power source of the DRAM is switched to the battery, the memory bank 1 of the DRAM enters into the self refresh mode because the data within the memory bank 1 of the DRAM is required to be retained after the computer is turned off. In this scenario, the battery within the computer continues to provide power so that the memory bank 1 in the self refresh mode can continue to retain data. Please note that the self refresh mode is a type of operating mode in the method of the modern computer. The self refresh mode is originally utilized when the computer enters into a power saving mode or a sleep status such that the DRAM is not required to wait for an access command from the north bridge 11 but a clock is controlled to self refresh to maintain the retained data. The present invention utilizes an existing mechanism which is utilized when the computer is turned on, the memory band of the DRAM through the power provided by the battery can self refresh continuously to retain the data within the DRAM.

As illustrated in FIG. 3, the method of the present invention can be applied when there is a power failure so that power can be provided to the DRAM to execute the self refresh to safely retain the data within the DRAM when the computer is turned off. However, when the computer is being restarted, a related program is required to retrieve the retained data when the computer was turned off to prevent damage to the data within the DRAM during hardware initialization when the computer is turned on.

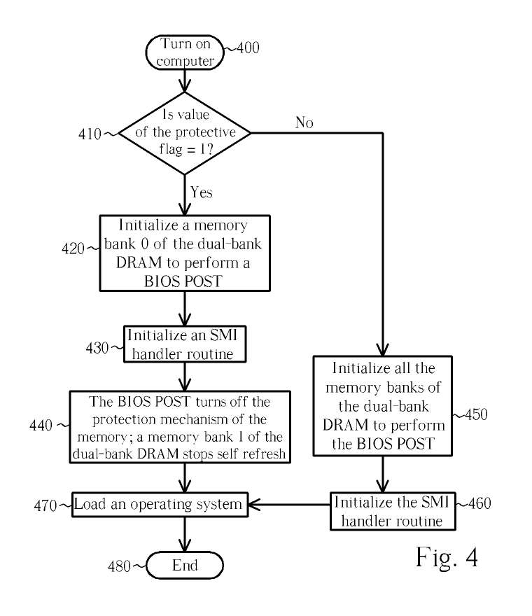

Please refer to FIG. 4. FIG. 4 illustrates a second portion of a flowchart of computer data protection according to the method of the present invention.

Step 400: turn on computer;

Step 410: check value of the protective flag; if 1 is detected, execute step 420; if a numeral other than 1 is detected, execute step 450;

Step 420: initialize a memory bank 0 of the dual-bank DRAM to perform a basic input/output system POST (BIOS POST);

Step 430: initialize an SMI handler routine;

Step 440: the BIOS POST turns off the protection mechanism of the memory and stops the memory bank 1 of the dual-bank DRAM from self refresh;

Step 450: initialize all the memory banks of the dual-bank DRAM to perform the BIOS POST;

Step 460: initialize the SMI handler routine of the computer;

Step 470: load an operating system;

Step 480: end.

According to the present invention, the value of the protective flag is checked in step 410 when the computer is turned on. The primary purpose is to check, before the computer executes a normal booting sequence, if the computer was most recently turned off due to a power failure. If the value of the protective flag is not 1, then a power failure did not occur, thus the computer can execute step 450 to step 470, which is the normal booting sequence. Please note that the present invention initializes the full dual-bank DRAM (including the memory bank 1 and bank 0) in step 450 to perform the BIOS POST regardless of the status of the protective flag. Additionally, the SMI handler routine is initialized in the following step 460. Lastly, the operating system is loaded to complete the booting sequence.

Alternatively, if the computer was most recently turned off due to a power failure, the value of the protective flag detected in step 410 is 1. In this case, before the computer is turned on again, the procedure provided by the present invention is required to safely retrieve the data retained within the memory bank 1 of the dual-bank DRAM. The present invention utilizes the special characteristic of the two memory banks of the dual-bank DRAM, specifically, the capability of operating independently. In step 420, only the memory bank 0 of the dual-bank DRAM, in which no data stored, is utilized for performing the BIOS POST, hence the data within the memory bank 1 of the dual-bank DRAM can be retained. In step 430, the SMI handler routine is initialized. Next, in step 440, the memory bank 1 of the dual-bank DRAM performs the self refresh, at this time as the SMI mechanism is already activated making the mechanism ready when there is a power failure in the future, thus the memory bank 1 of the dual-bank DRAM is not required to store data in the self refresh mode.

As illustrated in step 420 to step 470 of FIG. 4, by following each step in the procedure the present invention can further realize a data loss prevention function. For example, consider the scenario where the computer is restarting due to a power failure, and another power failure occurs before the booting sequence is completed. Retained data may be lost if the memory bank 1 of the dual-bank 1 has stopped the self refresh process, and there is insufficient time to switch back to the self refresh mode. However, in the method of FIG. 4, the present invention ensures that the memory bank 1 of the dual-bank DRAM will only end the self refresh mode after the BIOS POST is completed and after the SMI handler routine is completed; therefore if a power failure occurs when execution is between steps 410 and 440, the memory bank 1 of the dual-bank DRAM can retain its data until the data is being released the next time the computer is turned on. In the event that a power failure occurs after step 440, the method of the present invention can re-execute the flowchart of FIG. 3 for retaining the data in the memory bank 1 of the dual-bank DRAM because the booting steps are completed.

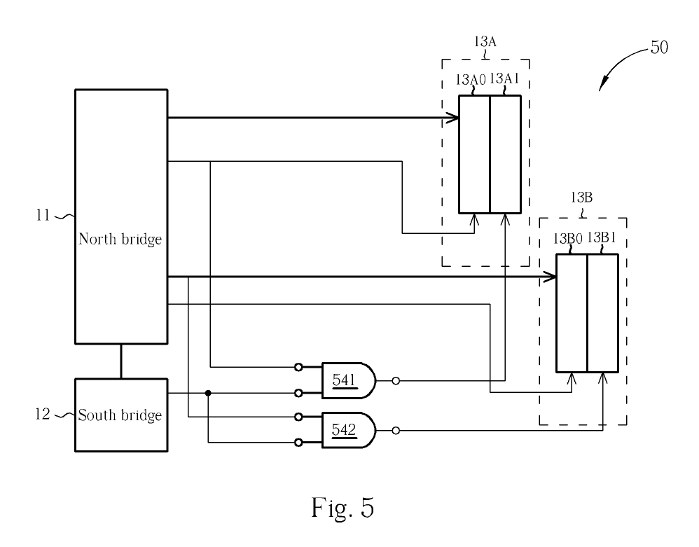

The method of data protection provided by the present invention can be realized by collocating hardware or software with the existing mechanism of the current computer. Please refer to FIG. 5. FIG. 5 illustrates a diagram of a control circuit of a dual-bank DRAM utilized by the method of the present invention according to an embodiment of the present invention. The control circuit 50 of the dual-bank DRAM utilized by the method of the present invention is respectively coupled to and controls the north bridge 11 and the dual-bank DRAM 13A and 13B; however, the south bridge 12 of the present invention further outputs a signal together with a control signal outputted from the north bridge 11 to the memory bank 13A1 and the memory bank 13B1 respectively for performing calculation with an AND gate 541 and an AND gate 542, and as a result, on and off of the protection mechanism of the memory is controlled through the south bridge 12. In another words, the present invention, through the south bridge 12, can control the memory bank 13A1 of the dual-bank DRAMI 3A, and control the memory bank DRAM 13B1 of the dual-bank 13B to enter or exit the self refresh mode to realize the design of data protection when there is an external power failure. For example, when the computer is turned on, the BIOS will control the south bridge 12 to determine transmitting a control signal to the memory band 13A1 of the dual-bank DRAMI 3A, and the memory bank 13B1 of the dual-bank DRAMI 3B. When the control signal transmitted by the south bridge 12 is 0 (low logic electrical potential), the memory bank 13A1 and the memory bank 13B1 will maintain at the self refresh mode; and when the control signal transmitted by the south bridge 12 is 1 (high logic electrical potential), the memory bank 13A1 and the memory bank 13B1 will be determined by the control signal transmitted by the north bridge. Therefore, the AND gate 541 and the AND gate 542 realize step 420 of the flowchart of FIG. 4.

In conclusion, the present invention provides a method of data protection for computers when there is an external power failure to prevent data from being damaged or lost. The method of the present invention utilizes existing mechanisms such as the dual-bank DRAM, SMI and DRAM, and the self refresh mode to collocate with a simple circuit to notify the south bridge to generate the SMI entry and activate the flowchart of data protection when there is a power failure. The present invention also provides corresponding steps after the computer is turned on to safely retrieve the data retained in the DRAM. The present invention can also be applied on computer architecture such as a redundant array of independent disks (RAID), and decision of write in of the data protected by the dual-bank RAM is to be decided by an upper strata. The present invention can also be applied on a multi-bank DRAM to retain data when there is a power failure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of data protection comprising:
examining if there is an external power failure when a computer enters into a system management interrupt (SMI) routine;
setting a protective flag to a first value when there is an external power failure;
switching power of a dual-bank random access memory (DRAM) to a battery; and
setting a first bank of the dual-bank DRAM into a self refresh mode.

2. The method of claim 1 further comprising:
checking the protective flag when the computer is turned on;
initializing a second bank of the dual-bank DRAM if a value of the protective flag is equal to the first value;
initializing the SMI routine of the computer;
the first bank of the dual-bank DRAM leaving the self refresh mode after the SMI routine is initialized; and
loading an operating system after the first bank of the dual-bank DRAM leaves the self refresh mode;
wherein the step of initializing the second bank of the dual-bank DRAM is to initialize the second bank of the dual-bank DRAM for the computer to process a BIOS POST routine.

3. The method of claim 1 further comprising:
checking the protective flag when the computer starts;
initializing the dual-bank DRAM when the protective flag is not the first value;
initializing an SMI routine of the computer after the dual-bank DRAM is initialized; and
loading an operating system after the SMI routine of the computer is initialized.

4. The method of claim 3 wherein the step of initializing the dual-bank DRAM is to initialize all memory banks of the dual-bank DRAM.

5. The method of claim 4 wherein the step of initializing all the memory banks of the DRAM is to initialize all the memory banks of the DRAM for the computer to perform a BIOS post.

6. The method of claim 1 further comprising:
setting a power failure register to a first value when external power fails.

7. The method of claim 1 wherein the step of examining if there is an external power failure when the computer enters into the SMI routine is to examine a value of a power failure register when the computer enters into the SMI routine.

8. The method of claim 1 further comprising:
setting the protective flag to a second value when external power fails.

9. The method of claim 1 further comprising:
starting an SMI routine when external power fails.

10. A method of data protection comprising:
examining if external power fails when a computer enters into a system management interrupt (SMI) routine; and
setting a protective flag to a second value when there is an external power failure.

11. The method of claim 10 further comprising:
checking the protective flag when the computer is turned on;
initializing a second bank of the dual-bank DRAM if the value of the protective flag is equal to a first value, wherein the first value is not equal to the second value;
initializing the SMI routine of the computer after the second bank of the dual-band DRAM is initialized;
a first bank of the dual-bank DRAM leaving the self refresh mode after the SMI routine is initialized; and
loading an operating system after the first bank of the dual-bank DRAM leaves the self refresh mode.

12. The method of claim 11 wherein the step of initializing the second bank of the dual-bank DRAM is to initialize the second bank of the dual-bank DRAM for the computer to process a BIOS POST routine.

13. The method of claim 10 further comprising:
checking the protective flag when the computer starts;
initializing the dual-bank DRAM when the protective flag is not equal to the first value;
initializing an SMI routine of the computer after the dual-bank DRAM is initialized; and
loading an operating system after the SMI routine of the computer is initialized.

14. The method of claim 13 wherein the step of initializing the dual-bank DRAM is to initialize all memory banks of the dual-bank DRAM.

15. The method of claim 14 wherein the step of initializing all the memory banks of the DRAM is to initialize all the memory banks of the DRAM for the computer to perform a BIOS post.

16. The method of claim 10 further comprising:
starting an SMI routine when external power fails.

17. A method of data protection comprising:
examining if there is an external power failure before a computer is turned on;
initializing a second bank of a dual bank random access memory (DRAM) when there is an external power failure before the computer is turned on;
initializing a system management interrupt (SMI) routine of the computer after the second bank of the dual bank DRAM is initialized; and
a first bank of the dual-bank DRAM leaving a self refresh mode after the SMI routine is initialized.

18. The method of claim 17 wherein the step of initializing the second bank of the dual-bank DRAM is to initialize the second bank of the dual-bank DRAM for the computer to process a BIOS POST routine.

19. The method of claim 17 further comprising:
loading an operating system after the first bank of the dual-bank DRAM leaves the self refresh mode.

20. The method of claim 18 further comprising:
setting a protective flag to a first value when there is an external power failure; and
starting an SMI routine when external power fails;
wherein the step of examining if there is an external power failure before the computer is turned on is to examine whether the protective flag is equal to the first value.
